(19) United States
(12) Patent Application Publication
(10) Pub. No.: US 2016/0201973 A1
(43) Pub. Date: Jul. 14, 2016

(54) COMPRESSOR MOUNTING BASE PLATE

(71) Applicant: DOW GLOBAL TECHNOLOGIES LLC, Midland, MI (US)

(72) Inventors: Ashishkumar S. Lokhande, Pune (IN); Onkareshwar V. Bijjargi, Pune (IN); Nilesh R. Tawde, Mumbai (IN); Gulab N. Malunjkar, Pune (IN); Paolo Diena, Modena (IT)

(73) Assignee: DOW GLOBAL TECHNOLOGIES LLC, Midland, MI (US)

(21) Appl. No.: 14/912,797

(22) PCT Filed: Sep. 17, 2014
(86) PCT No.: PCT/US2014/056025

§ 371 Date: Feb. 18, 2016

(30) Foreign Application Priority Data
Oct. 1, 2013 (IN) 4471/CHE/2013

(51) Int. Cl. F25D 23/00; F16M 5/00

(52) U.S. Cl. CPC F25D 23/006; F16M 5/00

(57) ABSTRACT

An elongated non-metal, non-corrosive compressor mounting base plate structure (40) including (I) a base plate segment (50) having a top surface (51) and a bottom surface, wherein the base plate segment (50) is adapted for receiving a compressor on the top surface (51) of the base plate (50); (II) a means for receiving and removably affixing a compressor to the top surface (51) of the base plate segment (50); and (III) a reinforcement means (60A, 60B) integral with said base plate segment (50); wherein said reinforcement means (60A, 60B) includes at least two elongated tubular reinforcement segments (60A, 60B) integral with the base plate segment (50), one tubular reinforcement segment (60A, 60B) at each of the elongated sides of the base plate segment (50) generally opposite each other in mirror image and generally parallel to each other along the longitudinal plane of the base plate segment (50); said reinforcement means (60A, 60B) being adapted for providing the compressor mounting base plate structure (40) with sufficient strength and rigidity such that the compressor mounting base plate structure (40) can withstand a deformation load from the weight of the compressor; and wherein the compressor mounting base plate structure (40) comprises a non-metal, non-corrosive structure.

### FIELD

The present invention relates to a compressor mounting base plate for an appliance such as a refrigerator; and more specifically, the present invention relates to a non-metal, non-corrosion compressor mounting base plate for a refrigerator, and a process for manufacture the compressor mounting base plate. The present invention also relates to a refrigerator installed with the above compressor mounting base plate for a compressor to be mounted thereon.

### BACKGROUND

Original equipment manufacturers (OEMs) that manufacture refrigerators are aspiring to shift from the OEMs' current convention design practice of steel stamped refrigerator parts to new technologies in designing and manufacturing of such refrigerator parts. The current trend in the home appliance industry is moving toward a wall-mounted refrigerator which will prompt OEMs to make such products lighter. For example, OEMs are looking to replace the current steel compressor mounting plate (which can be 1-2 kg in weight) of a current refrigerator with a light weight and a non-corrosive composite material compressor mounting base plate.

Generally, the lower portion or bottom structure of an appliance such as a refrigerator contains a machine compartment, a compressor, and a compressor mounting base plate for attaching the compressor to the base plate. The compressor mounting base plate is positioned under the rear part of the refrigerator bottom so as to define the machine compartment and the compressor mounting base plate supports the compressor mounted on the base plate located in the machine compartment.

FIGS. 1 and 2 show a conventional design of a refrigerator, generally indicated by numeral 10, illustrating some of the conventional parts of a refrigerator including a conventional steel compressor mounting base plate 11 affixed to the bottom portion of the refrigerator cabin 12 at a lower portion of a refrigerator cabin; and a conventional compressor 13 affixed to the top surface of the compressor mounting base plate 11. The compressor 13 is attached to the top surface of the compressor mounting base plate 11 via threaded bolts 14; and compressor support member brackets 16 attached to the compressor 13. Disposed in-between the brackets 16 and the surface of the compressor mounting base plate 11 are vibration damping members 17 for attenuating the vibrations of the compressor when the compressor is in operation. In addition, wheels 18 are attached to the compressor mounting base plate 11 to provide movement of the refrigerator when the compressor mounting base plate 11 is affixed to the refrigerator cabin 12.

FIGS. 3-5 illustrate another example of a conventional steel compressor mounting base plate in the form of a rectangular-shaped tray member generally indicated by numeral 20 which can be affixed to the bottom portion of a refrigerator unit of the prior art (not shown) and which is also adapted for receiving and affixing a conventional compressor (not shown) to the top surface of the compressor mounting base plate 21.

A typical compressor mounting plate of the prior art as shown in FIGS. 3-5 is made from 1 millimeter (mm) thick steel sheets. The compressor mounting plate 20 is usually manufactured using a steel sheet metal stamping process to form a compressor mounting base plate 21 having a top surface 22 and a bottom surface 23. Integral with the base plate 21 are longitudinal sidewalls 24 and transverse sidewalls 25 forming a tray member 20. A secondary operation is typically used to form flange tabs 26, flange holes 27, orifices 28, and orifices 29 in the sheet (see FIGS. 3 and 4). Typically, the finished steel compressor mounting plate part is about 1.2 kilograms (kg) in weight.

The compressor mounting base plate 21 contains a plurality of orifices, typically four orifices 29, for receiving a threaded bolt 31 and a threaded nut 32 (for purposes of illustration, one orifice 29 is shown in FIGS. 3 and 4 without nuts and bolts). The threaded bolts 31 and nuts 32 are used to affix the compressor to the compressor mounting base plate 21. A rubber damper member 33, shown in FIGS. 3-5, is inserted between the bolt and nut to providing damping during operation of the compressor. The compressor is attached to the top surface 22of the compressor mounting base plate via a bracket member (not shown in FIGS. 3 and 4, however, the bracket member may be similar to bracket 16 shown in FIGS. 1 and 2). Wheels 34 rotatably affixed to the compressor mounting base plate 21 are used to install the compressor mounting base plate into a refrigerator unit.

When a steel compressor mounting plate of the prior art is subjected to a corrosive environment, over time, the conventional steel compressor mounting plate corrodes and loses its strength. Also, the structural damping coefficient for steel is approximately 2 percent (%) which causes vibrations to transfer to the refrigerator cabin through a compressor mounting plate even though there are typically four rubber dampers fixed with the bolts and nuts on the steel sheet (for example see damping means 31, 32, and 33 shown in FIGS. 3-5) below the location of where the compressor support member brackets will be positioned (for example see brackets 16 shown in FIGS. 1 and 2).

Thus, OEMs in the home appliance industry are continually seeking appliance equipment and parts such as a compressor mounting base plate product for a refrigerator unit that can provide an improvement to the overall manufacture and cost of an appliance such as a refrigerator unit.

### SUMMARY

The present invention includes a compressor mounting base plate structure and design for an appliance device which uses a compressor; a motor; or an equivalent vibrating (reciprocating/rotating) apparatus such as a washing machine, a dishwasher, an air-conditioning unit, or a refrigerator unit. The compressor mounting plate exhibits beneficial characteristics which can also be critical customer requirements. For example, the compressor mounting base plate of the present invention can be light weight such that the compressor mounting base plate is from about 20% to 30% lighter than a steel plate. The compressor mounting base plate of the present invention also can be advantageously manufactured from a non-metal, non-corrosive composite material such as for example a polyurethane polymer.

In one preferred embodiment, for example, the compressor mounting base plate of the present invention includes an elongated non-metal, non-corrosive compressor mounting base plate structure useful for an appliance such as a refrigerator unit including:

(I) a base plate segment having a top surface and a bottom surface, wherein the base plate segment is adapted for receiving a compressor on the top surface of the base plate;

(II) a means for receiving and removably affixing a compressor to the top surface of the base plate segment; and

(III) a reinforcement means integral with said base plate segment; wherein said reinforcement means includes at least two elongated tubular reinforcement segments integral with the base plate segment, one tubular reinforcement segment at each of the elongated sides of the base plate segment generally opposite each other in mirror image and generally parallel to each other along the longitudinal plane of the base plate segment; said reinforcement means being adapted for providing the compressor mounting base plate structure with sufficient strength and rigidity such that the compressor mounting base plate structure can withstand a deformation load from the weight of the compressor; and wherein the compressor mounting base plate structure comprises a non-metal, non-corrosive structure.

Another aspect of the present invention includes a process for manufacturing the compressor mounting base plate. In one preferred embodiment for example, the process for manufacturing the compressor mounting base plate may include a pultrusion process.

The composite-based compressor mounting base plate of the present invention has several advantages over a conventional steel-based compressor mounting base plate. For example, the composite-based compressor mounting base plate structure of the present invention: (1) is light weight and up to 30% lighter in weight compared to a steel compressor mounting base plate; (2) is strong as a steel compressor mounting base plate; (3) exhibits no corrosion because the composite-based compressor mounting base plate of the present invention is made of a non-corrosive material such as a polyurethane polymer; (4) exhibits increased dynamic response under compressor loading conditions which is beneficial to restrict mechanical vibrations of the compressor during operation in an appliance device such as a refrigerator; and (5) is easily integrated into conventional parts of various appliance devices such as a conventional refrigerator.

In addition, one of the advantages of using the process of the present invention to manufacture a composite-based compressor mounting base plate over a steel-based compressor mounting base plate is that the process of the present invention allows a manufacturer to make a product that can be made with low tooling cost and low manufacturing process cost in an attempt to reduce part cost.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a perspective view of a back side lower portion of a refrigerator of the conventional art showing some parts of a refrigerator including a machine compartment of a refrigerator containing a steel compressor mounting base plate of the conventional art installed in the lower portion of the refrigerator, and a compressor of the conventional art mounted on the steel compressor mounting base plate.

FIG. 2 is a rear view, partly in cross-section, of the lower portion of the refrigerator of FIG. 1 showing the machine compartment of the refrigerator according to the conventional art.

FIG. 3 is a perspective view of a steel compressor mounting base plate of the conventional art adapted to being installed in a refrigerator.

FIG. 4 is a top view of a steel compressor mounting base plate of the conventional art.

FIG. 5 is a cross-sectional view of a steel compressor mounting plate of the conventional art taken along line 5-5 of FIG. 5.

FIG. 6 is a perspective view of one embodiment of a compressor mounting base plate of the present invention.

FIG. 7 is a top view of the compressor mounting base plate of FIG. 6.

FIG. 8 is a cross-sectional view taken along line 8-8 of FIG. 6.

FIG. 9 is a side view taken along line 9-9 of FIG. 6.

FIG. 10 is a cross-sectional view taken along line 10-10 of FIG. 6.

FIG. 11 is a cross-sectional view taken along the longitudinal length of a portion of a base plate segment of another embodiment of a compressor mounting base plate structure of the present invention.

### DETAILED DESCRIPTION

“Light weight”, with reference to a composite compressor mounting base plate, herein means a reduced mass of the composite compressor base plate compared to a conventional steel compressor mounting base plate which typically can weigh from 1 kg to 2 kg in weight.

“Dynamic response”, with reference to a compressor mounting base plate, herein means the required dynamic stiffness of the compressor mounting base plate sufficient for the compressor mounting base plate to sustain and to isolate vibration of a compressor while providing the required stiffness of the compressor mounting base plate sufficient for the compressor mounting base plate's end use operation.

“Strong”, with reference to a compressor mounting base plate, means the required static stiffness of the compressor mounting base plate sufficient for the compressor mounting base plate to contain/withstand the mass of a compressor.

The composite compressor mounting base plate of the present invention has been developed keeping in mind the above problems occurring in the prior art.

A conventional compressor is typically used in refrigerators. The compressor is an apparatus for compressing a low temperature/low pressure refrigerant into a high temperature/high pressure refrigerant and discharging the high temperature/high pressure refrigerant therefrom. After the discharged refrigerant is heat-radiated to an atmosphere and is changed into the low temperature/low pressure refrigerant via an expansion unit, the low temperature/low pressure refrigerant absorbs heat from inside of the refrigerator.

While the compressor operates, vibration is generated from the compressor; and the generated vibration is transmitted to other elements of the appliance device connected to the compressor without damping, thereby generating a noisy vibration from the whole device through each element of the device connected to the compressor. Therefore, one objective of the present invention is to provide a compressor mounting base plate structure that advantageously prevents, reduces or attenuates the transmittance of vibration generated from the compressor through the compressor mounting base plate structure supporting the compressor to the other elements of an appliance device such as a refrigerator main body and frame.

A compressor, used in appliance devices such as refrigerators, also commonly operates in a corrosive environment due to the moisture created by condensation in the machine room where the compressor is located. Therefore, another object of the present invention is to provide a compressor mounting base plate structure for a refrigerator that is made of a non-corrosive synthetic resin material.

Another object of the present invention is to provide a compressor mounting base plate structure that is sufficiently strong and capable of withstanding the load conditions of a compressor at the location where the compressor mounting base plate is installed; and thus, preventing deformation of the compressor mounting base plate such as when a heavy compressor is affixed to the compressor mounting base plate.

Another objective of the present invention is to provide a compressor mounting base plate structure having improved impact resistance.

The lower portion of a conventional refrigerator typically includes a machine compartment casing (also referred to as a “machine room”) made of metal; a conventional compressor made of metal, and a compressor mounting base plate also made of metal. Thus, the total overall weight of the refrigerator unit including the compressor and the compressor mounting base plate is typically very heavy; and the total overall manufacturing cost of the refrigerator unit is quite high. Therefore, a further object of the present invention is to provide a compressor mounting base plate structure that is light weight by fabricating the compressor mounting base plate structure with a light weight composite material. By incorporating such light weight compressor mounting base plate structure made of composite material into a refrigerator unit can reduce the overall weight of the refrigerator unit.

Still another object of the present invention is to simplify the parts of a refrigerator that are disposed in the machine compartment casing located at the lower structure of the refrigerator to thereby reduce manufacturing costs and improve assembly efficiency of the refrigerator. For example, in one embodiment of the present invention, the fabrication of the compressor mounting base plate structure is simplified by fabricating a single piece compressor mounting base plate structure using a simple fabrication process such as a pultrusion process, wherein the fabrication costs for fabricating the compressor mounting base plate structure and a refrigerator are reduced.

The present invention compressor mounting base plate structure may be advantageously used as part of a machine compartment casing of a refrigerator wherein the compressor mounting base plate engages the lower portion of a conventional refrigerator and wherein the top surface of the compressor mounting base plate defines the bottom portion of the machine compartment casing of the refrigerator.

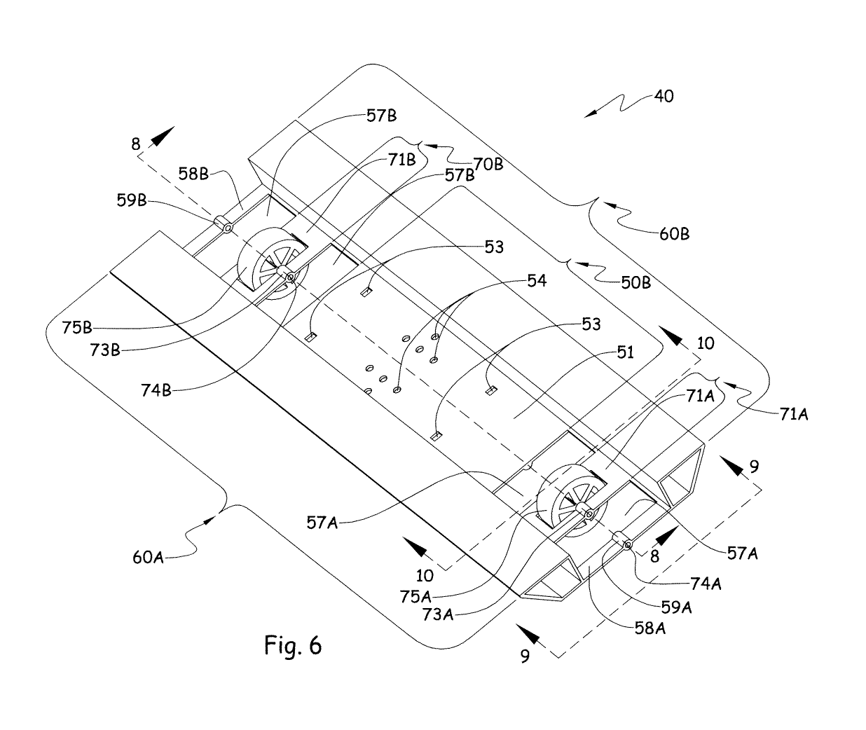

With reference to FIGS. 6-10, there is shown one embodiment of a compressor mounting base plate of the present invention made using a pultrusion process. The compressor mounting base plate structure (herein referred to as “the base plate”) includes an elongated, non-metal, non-corrosive structure. The base plate of the present invention, shown in FIGS. 6-10, is generally indicated by reference numeral 40.

The base plate 40 includes a combination of a middle or central base plate section or segment generally indicated by numeral 50; and a structural reinforcement means made up of a first and second reinforcing sections generally indicated by numerals 60A and 60B, respectively, which are integrally connected to the base plate segment 50. Optionally, in another embodiment a supplemental structural reinforcement means made up of first and second supplemental reinforcing sections (not shown) generally are disposed transverse at the proximal and distal ends of the reinforcing means 60A and 60B, respectively: and which are integrally connected to the base plate segment 50 and integrally connected to the reinforcing sections 60A and 60B, respectively. The optional supplemental structural reinforcement means may function to (1) contribute to the reinforcement of the base plate 40, and (2) receive and removably affix wheel members to the base plate 40.

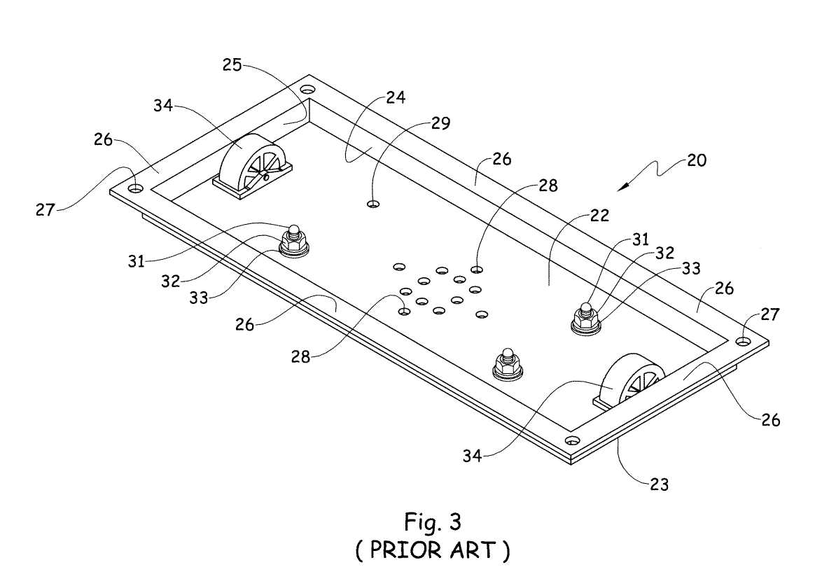

The base plate segment, generally indicated by numeral 50, is adapted for receiving and removably affixing a compressor (not shown in FIG. 6, however, the compressor of the present invention may be similar to a conventional compressor 13 shown in FIG. 2) to the base plate segment 50 of the base plate 40. The base plate segment 50, as shown in FIGS. 6-8, is generally flat or substantially planar, and has a top surface 51 and a bottom surface 52. The base plate segment 50 is adapted for receiving the compressor, via one or more orifices 53, and is adapted for receiving a means for mounting/affixing a compressor to the top surface 51 of the base plate. The means for affixing a compressor to the base plate segment may be generally disposed toward the middle or central portion of the base plate segment 50.

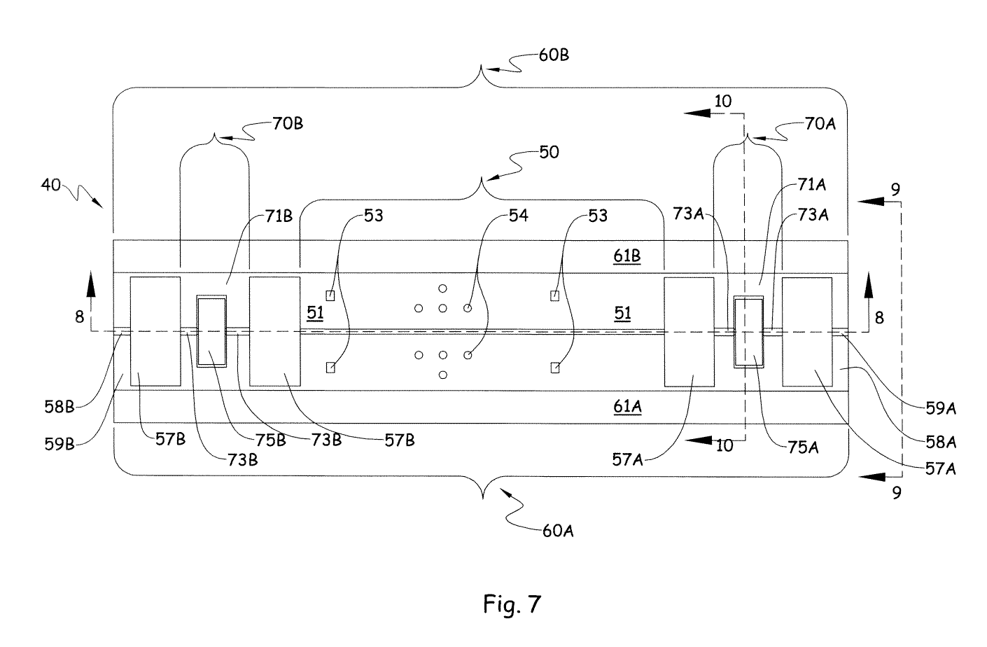

The base plate segment 50, shown in FIGS. 6-10, may optionally contain one or more venting orifices 54 for allowing air to pass through the venting orifices 54 and to circulate throughout the machine compartment casing of a refrigerator unit; and to allow drainage of any standing water on the surface 51 of the base plate 40. For example, as shown in FIGS. 6 and 7, a plurality of venting orifices 54 are disposed generally in the central or middle portion of the base plate segment 50.

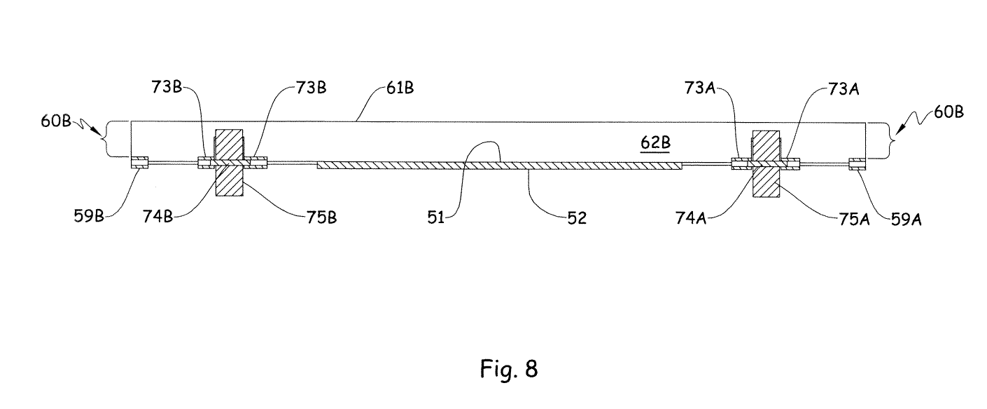

In one embodiment, the base plate 40 of the present invention can include, as an optional structural element, at least one load bearing/load distributing structure member integral with the base plate 40 and adapted for providing additional strength, reinforcement and integrity to the base plate 40. For example, as shown in FIG. 11, the load bearing/load distributing structure can be a raised surface area generally indicated by numeral 55 in at least a portion of the base plate segment 50 of the base plate 40. The raised area 55 is adapted for receiving the compressor and affixing the compressor to the raised surface are 55 via orifices 56 as shown in FIG. 11 (for example, the orifices 56 may be similar to orifices 53 of FIG. 8); and nuts and bolts (not shown).

In one embodiment, the base plate segment 50 of the base plate 40 can optionally be one continuous flat sheet piece integral with the first and second reinforcing sections 60A and 60B; or, as shown in the embodiment of FIGS. 6-10, optional spacings or slots 57A can be disposed at one proximal end of the base plate segment 50; and optional spacings or slots 57B can be disposed at the other distal end of base plate segment 50. Also shown in FIGS. 6-10 may be a structural means adapted for receiving and removably attaching a means for moving the refrigerator unit, including mounting means generally indicated by numeral 70A and 70B described herein below.

After the base plate 40 is affixed to the lower portion of the refrigerator unit; the base plate 40 of the present invention, in one embodiment shown in FIGS. 6-10, can optionally include the structural means 70A and 70B, integral with the base plate 40, adapted for receiving and removably attaching a means for moving the refrigerator unit to its location of operation. The structural means 70A and 70B may also be used for moving the base plate 40 to and from the machine compartment case at the lower portion of a refrigerator unit during installation of the base plate 40 to the refrigerator unit.

In one preferred embodiment, the structural means adapted for receiving and removably attaching a means for moving the refrigerator unit can be for example a wheel mounting means 70A and 70B including a planar base plate strip member 71A and 71B integral with the sidewalls 62A and 62B being disposed transverse to the horizontal plate of the base plate segment 50 near the transverse ends of the base plate segment 50 and perpendicular to the sidewalls 62A and 62B. The strip member 71A,71B include a slot 72A, 72B, respectively. The slots 72A, 72B, are adapted for removably receiving and removably attaching wheel members 75 and axle bearing tube members 73 integral with the strip member 71. The tubular members 73 of the strip members 71 are adapted for receiving rod axle members 74. The strip members 71A can be disposed in-between the slots 57 at one proximal end of the base plate segment 50; and the strip member 71B can be disposed in-between the slots 57 at the other distal end of base plate segment 50.

When slots 57 are formed in the base plate segment 50, additional narrow planar base plate strip members 58 can additionally be formed in the base plate segment 50. The strip planar base plate strip members 58 can include tubular member 59 to aid in attaching the axle 74 to the wheel mounting means 70; and/or, the strips 58 can function as additional supplemental reinforcement section means, the strip planar base plate strip members 58 being disposed transverse to the horizontal plate of the base plate segment 50 near the transverse ends of the base plate segment 50. That is, the strip planar base plate strip members 58 may be located at near both ends of the base plate 40, i.e. at near the proximal end and at near the distal end of the base plate 40, respectively, to provide even further reinforcement to the base plate 40

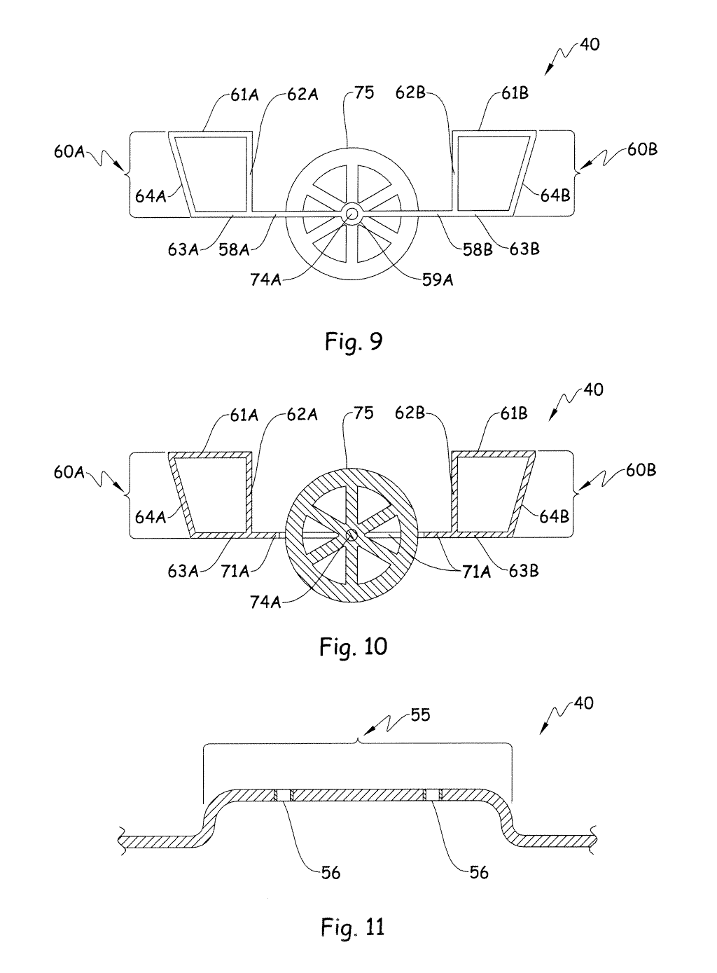

The optional supplemental strip members 58 of the present invention may comprise at least two strip members similar to the strip member 71 described above. However, the strip members 58 can be relatively narrower in width than the strip member 71 as shown in FIGS. 6 and 7. For example, one planar strip member 58A, as shown in FIGS. 6-10, is disposed at near the proximal end of the base plate 40 and the other planar strip member 58B is disposed at near the distal end of the base plate 40. The strip members 58A and 58B are integral with the base plate 40 and advantageously provides the base plate 40 with further increased strength and rigidity, which allows the base plate 40 to withstand deformation load from the weight of a compressor. The side view in FIG. 9 shows the strip member 58B connected to reinforcing members 60A and 60B together forming a linear strip member reinforcing structure that advantageously provides the base plate 40 with added structural stability.

The means for moving the refrigerator unit removably attached to the base plate 40 structure includes as one example, at least two wheel members 75. One of the wheel members can be removably attached to the base plate segment 50 via structure 70A and the other of the wheel member 75 can be removably attached to the base plate 50 via structure 70B. In addition, each of the straight strip members 58 include a tubular member 59 for receiving and passing therethrough the rod axle member 74 to position the axle member 74 in the tube members 73 and for removably attaching the wheel member 75 to the strip member 71. The wheels 75 attached to the base plate 40 provide a means for easily moving the refrigerator with base plate into position for use.

In a preferred embodiment, the strip members 71A and 71B are disposed near the proximal end and distal end of the base plate 40 and in-between the slots 57 of the base plate segment 50, thus preferably placing the wheels near the proximal and distal ends of the base plate 40.

FIGS. 6-8 show the top surface 51 with the orifices 53 which are adapted for receiving and removably mounting or affixing a compressor to the top surface 51 of the base plate segment 50 generally in the central portion of the base plate segment 50.

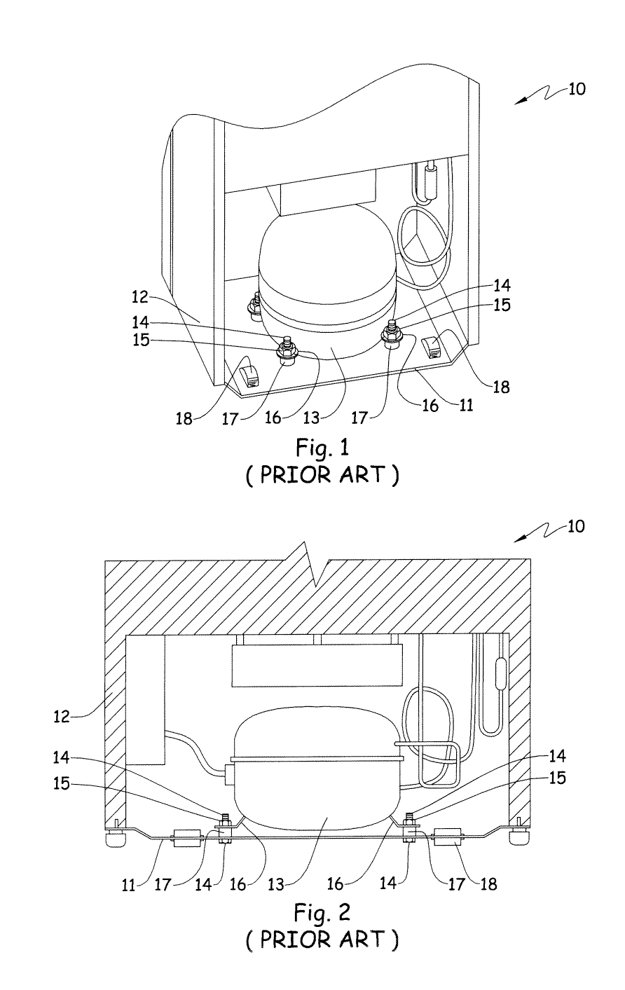

The compressor mounting means of the present invention includes for example one or more orifices 53 for receiving therethrough a threaded bolt (not shown in FIG. 6, however, the threaded bolt of the present invention may be similar to a conventional bolt 27 shown in FIG. 3). The threaded bolt can be inserted through the orifice 53 from the bottom surface 52 of the base plate 50 to the top surface 51 of the base plate and secured with a threaded nut (not shown in FIG. 6, however, the threaded nut of the present invention may be similar to a conventional threaded nut 15 shown in FIGS. 1 and 2). The threaded nuts are used for engaging and locking the threaded bolts in place; and to secure the compressor on the base plate via support mounting brackets (not shown in FIG. 6, however, the brackets of the present invention may be similar to conventional support mounting brackets 16 shown in FIG. 2) attached to the compressor.

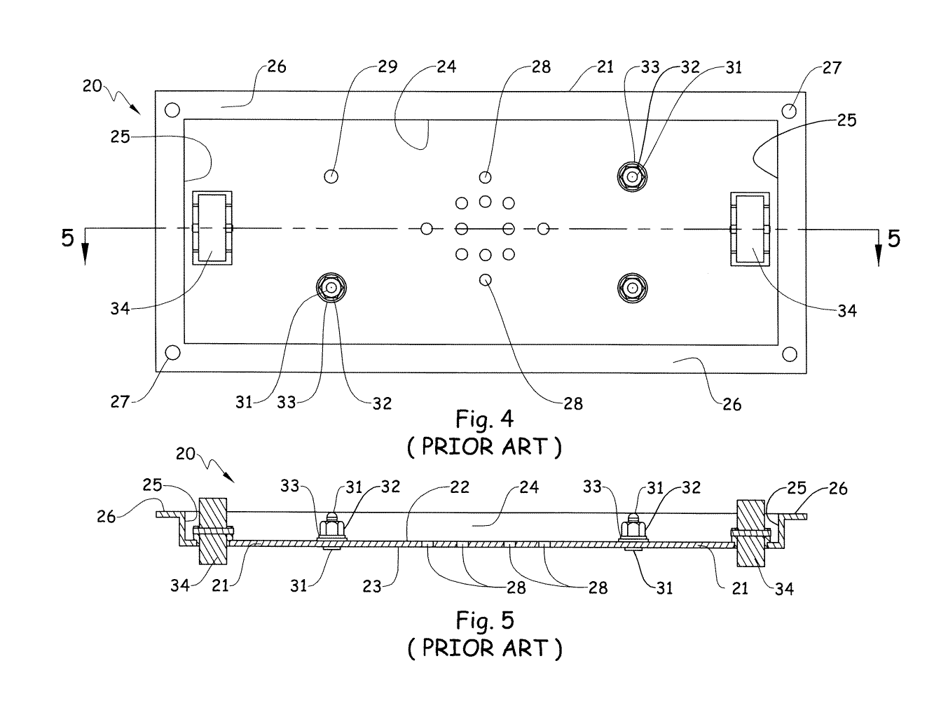

Inserted in-between the support mounting brackets attached to the compressor and the top surface 51 of the base plate segment 50 is one or more vibration damper members (not shown in FIG. 6, however, the vibration damper members of the present invention may be similar to conventional dampers 17 shown in FIG. 2). Generally, the vibration damper members are made of rubber, and used to dampen the vibrations caused by the operation of the compressor. The compressor can be removably affixed to the top surface 51 of the base plate segment 40 via threaded nuts and bolts inserted through orifices 53 in the base plate 40 (see FIGS. 1-5 for similar orifices, nuts and bolts).

The at least two elongated reinforcement sections or segments 60A and 60B of the base plate 40 are integral with the base plate segment 50 at the elongated sides of the base plate segment 50 and are adapted for reinforcing the base plate 40. The elongated reinforcement segments 60A and 60B advantageously provide the base plate 40 with increased strength and rigidity sufficient for the base plate 40 to withstand a deformation load from the heavy weight of a compressor. Typically, a compressor is made of steel and very heavy; and the weight of a compressor plate (which can be from 1-2 kg in weight) can add weight to the overall weight of the appliance in which the compressor plate is used.

With reference to FIGS. 6-10 again, there is shown one embodiment of the elongated reinforcement segments 60A, 60B integral with the base plate segment 40. For example, the elongated reinforcement segments 60A, 60B, herein referred to as at least a first reinforcing structure member 60A and at least a second reinforcing structure member 60B, respectively, each comprise an elongated top ledge portion 61A and 61B respectively, an elongated vertical sidewall portion 62A and 62B respectively, elongated bottom ledge portion 63A and 63B respectively, and an elongated angled sidewall portion 64A and 64B respectively as shown in FIG. 9. The first and second reinforcing structure members 60A, 60B are disposed integrally with the base plate segment 50—one reinforcing structure member on each side of the longitudinal length of the top surface of the base plate segment 50. The first and second reinforcing structure members 60A, 60B are disposed parallel to each other on opposite sides of the longitudinal length of the top surface of the base plate segment 50.

In the embodiment shown in FIGS. 6-10, the first reinforcing structure member 60A and the second reinforcing structure member 60B, are shown as trapezoidal-shaped tubular members, when viewed in a side view as shown in FIGS. 9 and 10. The trapezoidal-shaped tubular members 60A and 60B comprise an elongated top ledge portion 61A, 61B, an elongated vertical sidewall portion 62A, 62B, an elongated bottom ledge portion 63A, 63B and an elongated angled sidewall portion 64A, 64B, each portion 61-64 being integral with each other.

When viewed in cross-section, the first trapezoidal-shaped tubular member reinforcing structure member 60A is disposed along one longitudinal side of the base plate segment 50. The second trapezoidal-shaped tubular member reinforcing structure member 60B is disposed along the other longitudinal side of the base plate segment 50. The trapezoidal-shaped tubular members face each other in parallel and in opposite directions to each other. For example, the structure members 60A and 60B are disposed in mirror image to each other. Thus, in one embodiment, the combination of sidewall 62A, sidewall 62B and base plate segment 50 forms a U-shaped member when viewed in a transverse cross-section at one end of the reinforcing structure members 60A, 60B as shown in FIGS. 9 and 10.

In a preferred embodiment, the compressor mounting base plate structure of the present invention includes the first reinforcing structure member on one longitudinal side of the base plate segment comprising a trapezoidal-shaped tubular member; and the second reinforcing structure member on the other longitudinal side of the base plate segment comprising a trapezoidal-shaped tubular member in mirror image to the first reinforcing structure member.

The first reinforcing structure member 60A and the second reinforcing structure member 60B are integral with the base plate segment 50. In FIGS. 6-10, the base plate 40 is shown as rectangular in shape with the reinforcing structure members 60A and 60B also functioning to provide vertical sidewall members 62A and 62B on each side of the base plate segment 50 to form a tray member (or pan member). The base plate 40 is shown as a rectangular-shaped member. However, the shape of the base plate 40 is not limited to a rectangle, but may include any shape desired that meets the requirements for a refrigerator unit including shapes such as an oval, a triangle, a pyramid, a square, and the like.

In addition, the trapezoidal-shaped tubular members 60A, 60B comprise a shape that is conducive to and facilitates the fabrication of the compressor mounting base plate structure of the present invention using for example a pultrusion process. However, the shape of the first and second reinforcing structure members 60A, 60B is not limited to a trapezoidal-shaped tubular member, but may include any shape desired that meets the requirements for reinforcing the base plate and for functioning in appliance equipment where the base plate is used, such as a refrigerator unit. Each one of the reinforcing structure members 60A, 60B, therefore, can be any shape that provides the required strength to the base plate 40. In another embodiment, for example, each of the reinforcing structure members 60A, 60B, can include a hollow elongated member in the shape of a triangle, an oval, rectangle, pyramid, square and the like. In another embodiment, members 60A and 60B can be a solid elongated bar or rib in any of the aforementioned shapes and integral with the base plate. In general, the reinforcing structure members 60A, 60B of the present embodiment shown in FIGS. 6-10 are trapezoidal-shaped tubular members and open at both ends of the tubular member in order to simplify the fabrication process via pultrusion and to minimize fabrication costs.

In the embodiment shown in FIGS. 6-10, the sidewalls 62A and 62B integral with the base plate segment 50 are coterminous with the sidewall portions 62A and 62B of the reinforcing structure members 60A, 60B; and the vertical sidewalls 62A and 62B of the base plate 40 generally have a plane that is disposed perpendicular to the horizontal plane of the base plate segment 50 such that a tray member 40 is formed with the top surface 51 of the base plate segment 50 functioning also as the bottom portion 51 of the tray member 40. The bottom portion 51 of the tray member 40 (or top surface 51 of the base plate segment 50) is adapted for receiving a compressor.

In addition, optionally the compressor mounting base plate structure 40 can include a means (not shown) for removably attaching the compressor mounting base plate to the machine compartment casing of the lower portion of a refrigerator unit. The removable attachment means can be for example one or more nuts and bolts removably affixed through an orifice (not shown) on the elongated top ledge portions 61 of the first and second reinforcing structures. The ledge portions 61 of the first and second first reinforcing structure members 60 are adapted to contain such means for attaching the compressor mounting base plate structure to the lower portion of a refrigerator unit.

In FIGS. 6-10, the base plate 40 is shown without a sidewall at a proximal end of the base plate 40; and without a sidewall at a distal end of the base plate 40; i.e., the two ends of the base plate 40 are open. In another embodiment, the base plate 40 may optionally include one or more additional or supplemental reinforcement means (not shown). For example, in one preferred embodiment, the base plate 40 of the present invention may includes an additional or supplemental reinforcement means similar to reinforcement sections or segments 60A and 60B except that the supplemental reinforcement means comprise reinforcing sections being disposed transverse to the horizontal plate of the base plate segment 50 at the extreme transverse ends of the base plate segment 50. That is, the supplemental reinforcing sections can be located at both ends of the base plate 40, i.e. at the proximal end and at the distal end of the base plate 40 to provide further reinforcement to the base plate 40.

Each one of the optional supplemental reinforcing sections of the present invention may be integral with the base plate 40 and, when used, are integral with reinforcing sections 60A and 60B forming a rectangular tray member with four sidewalls. The supplemental reinforcing sections advantageously provides bending rigidity to the base plate 40 in the transverse direction of the base plate 40 with further increased strength and rigidity, which allows the base plate 40 to withstand deformation load from the weight of a compressor when said compressor is heavy weight such as up to 2 kg.

Optionally, in another embodiment, the base plate 40 of the present invention shown in FIGS. 6-10, can include a means (not shown) for receiving and retaining liquid condensation that may occur in the machine compartment casing of a refrigerator unit during operation of the refrigerator unit.

For example, the means for receiving and retaining liquid condensation may comprise a dip tray member (not shown) either integral with the base plate 40; or removably attached to the top surface 51 of the base plate segment 50 of the base plate 40. As aforementioned, the dip tray member is adapted for collecting a liquid, i.e., the drip tray is used to capture and collect water formed through condensation or other liquid in the machine compartment of the refrigerator unit. In a preferred embodiment, the compressor mounting base plate structure of the present invention includes a drip tray member removably attached to the top surface 51 of the base plate segment 50, such that the drip tray member is adapted for collecting moisture and condensation.

Generally, in one embodiment of the present invention, the compressor mounting base plate structure can be a one-piece body member made of a non-metal, non-corrosive synthetic resin or composite material. For example, the composite material can be a synthetic thermosetting resin material such as a polyurethane polymer resin, an epoxy resin, or a polyester resin. In a preferred embodiment, the one-piece body member can be made from curable composition including a combination of (a) a synthetic thermosetting resin matrix binder material and (b) a reinforcement material. Generally, the curable composition is prepared by admixing a thermosetting resin material a curing agent to form the binder material; and then a reinforcing material is added to the binder material.

A wide variety of reinforcement materials can be suitable for use in producing the compressor mounting base plate structure. In one preferred embodiment, a fiber reinforcement material is used. For example, fiber reinforcing materials may include woven fibers, non-woven (random) fibers, or a combination thereof.

Examples of suitable reinforcing fibers useful for the curable composition or formulation may be selected from fibers, such as for example but not limited to, mineral or ceramic fibers such as Wollastonite, aluminum, glass fibers, carbon fibers and the like; synthetic fibers of nylon, polyester, aramid, polyether ketones, polyether sulfones, polyamides, silicon carbon, and the like; natural fibers such as cellulose, cotton, hemp, flaxes, jute and kanaf fibers; metal fibers; and mixtures thereof. Biocomponent fibers such as a non-glass material spun bonded non-woven having a polyester core and polyamide skin, may also be used.

Glass fiber, either woven or non-woven, such as fiber made from E-glass and S-glass, is the preferred reinforcement material used in the present invention due to its low cost and physical properties. Typically, the reinforcing fibers have an average length of at least 1 mm. The reinforcing fibers may also have a diameter of between about 5 microns and about 20 microns. The fibers may be used in the form of chopped strands or individual chopped filaments.

The matrix binder useful in the present invention for the composition or formulation for constructing the composite body defining the compressor mounting base plate structure may be a thermoset polymer or a thermoplastic polymer. Typically the matrix binder is selected from a group of materials consisting of polyolefins, polyesters, polyamides, polypropylene, copolymers of polyethylene and polypropylene, polyethylene, nylon 6, nylon 66, high heat nylons, copolymers of nylon 6, nylon 66 and high heat nylons, polycarbonate/acrylonitrile butadiene styrene blend, styrene acrylonitrile, polyphenylene sulfide, polyvinyl chloride, polybutylene terephthalate, polyethylene terephthalate, polyurethane, epoxy, vinyl ester, phenolic compound, dicyclopentadiene and mixtures thereof. The matrix binder may be used in liquid form, powder form, pellet form, fiber form and/or bi-component fiber form. The physical form of these matrix materials (i.e., their viscosities, particle sizes, etc.) is well-known in the art, variable to be compatible with the particular pultrusion process chosen to fabricate the composite, and typical of “standard” matrix materials known in the industry.

Generally, the composite body comprises between about 20 weight percent (wt %) and about 50 wt % reinforcing fibers and between about 50 wt % and about 80 wt % matrix binder. In one embodiment, the composite body has a density of between about 1.0 g/cm³ and about 2.0 g/cm³.

In a preferred embodiment, a polyurethane-isocyanate composition can be used in the present invention as the synthetic material binder matrix with various reinforcement materials to produce the compressor mounting base plate structure.

There may be several methods used for forming the curable formulation or composition for preparing the base plate of the present invention. For example, in one embodiment, the curable composition is prepared by mixing a thermosetting resin matrix material and the fiber reinforcement material described above. In addition, the preparation of the binder resin matrix and reinforcement material composition or formulation of the present invention, and/or any of the steps thereof, may be a batch or a continuous process. The mixing equipment used in the process may be any vessel and ancillary equipment well known to those skilled in the art.

In general, the composition for fabricating the compressor mounting base plate structure according to an exemplary embodiment of the present invention can be formed by mixing the synthetic resin matrix material and the reinforcement material such as reinforcing fibers arranged to be processed according to a pultrusion process described herein below. That is, the compressor mounting base plate structure may be fabricated by combining the reinforcing fibers with the resin matrix material.

The compressor mounting base plate composite article of the present invention which is useful in refrigerators is preferably made of a synthetic resin through the use of a pultrusion process. In the present invention, a most suitable preferred embodiment is to form the compressor mounting base plate structure by using a pultrusion process in order to maximize the strength of the compressor mounting base plate structure and reduce the fabrication costs of the compressor mounting base plate structure.

For example, as is well known in the art, pultrusion is the process of “pulling” raw composite material, such as fiberglass and resin, through a shaped heated die creating a continuous composite profile. The profile that exits the die is a cured pultruded Fiber Reinforced Polymer (FRP) composite. In a preferred embodiment, a pultrusion process can be used in the present invention to fabricate the compressor mounting base plate in a pultruded one-piece body made of a non-metal, non-corrosive composite material. The pultrusion process uses glass fiber and a thermosetting resin to make a structurally strong composite. A pultrusion process useful in the present invention is described for example in U.S. Pat. No. 7,056,796; incorporated herein by reference.

A typical pultrusion process includes for example the following general steps:

Step (1): A reinforcement material in the form of raw fiber (e.g., glass, carbon, aramid, or mixtures thereof) is pulled off of doffs or rolls from a creel racking system.

Step (2): The raw fiber being pulled off the racks in Step (1) are guided through a resin bath or resin impregnation system. The resin bath includes the raw resin matrix composition comprising a thermosetting resin, optionally combined with fillers, catalysts, pigments and other additives. The resin can be polyester resin, vinyl ester, epoxy or urethane as described above. As the fibers are passed through the resin bath, the fibers become fully impregnated (wetted-out) with the resin matrix such that all the fiber filaments are thoroughly saturated with the resin mixture.

Step (3): Using guiding systems, the impregnated fibers of Step (2) are led through a heated die. The entrance of the heated die is often cooled to avoid curing the resin while excess resin is squeezed off.

Step (4): As the fiber and resin is pulled through the heated die in Step (3), the resin cures and exits as a fully formed composite. The shape of the pultruded composite part will match the shape of the die. The profile that exits the die is a cured pultruded profile which can be referred to as a Fiber Reinforced Polymer (FRP) composite. The pulling action in this process is accomplished by a set of “pullers” or “grippers” which are pulling the material at a continuous and consistent rate.

Step (5): At the end of the pultrusion process, a cut-off saw is used to cut the pultruded profiles from Step (4) to a specific desired length and then the cut pultruded profiles are stacked for delivery.

In one embodiment of the compressor mounting base plate structure as shown in FIG. 6, the above pultrusion process is used for example with a polyurethane resin and a glass fiber reinforcement to form a composite. The thickness of the composite compressor mounting base plate structure can be from about 0.5 mm to about 20 mm in one embodiment; and from about 0.8 mm to about 5 mm in another embodiment

The resulting compressor mounting base plate structure fabricated with the present invention process can have a combination of properties that makes the base plate of the present invention superior to conventional base plates made of metal such as iron or aluminum for example in a specific strength. For example, the static stiffness of a compressor mounting base plate structure made from steel is typically about 634 N/mm, whereas the static stiffness of the compressor mounting base plate structure according to an exemplary embodiment of the present invention can be about 679 N/mm. In addition, dynamic stiffness of an exemplary embodiment of the present invention can be for example 30 Hz as its first frequency where as for a steel base plate typically the dynamic stiffness is 21 Hz under modal analysis. Accordingly, the base plate of the present invention can have the same strength as that of the existing conventional steel base plate but the weight of the base plate of the present invention can be minimized.

In a preferred embodiment, the resin matrix material used in the present invention may be epoxy or polyester in terms of costs and effectiveness. In addition, the reinforcing fibers used in the present invention may be glass fibers which are low-priced and have a suitable strength. In other embodiment, the reinforcing fibers can be other nonmetal fibers such as boron, carbon, graphite, Kevlar, and the like as described above.

In a preferred embodiment, the resin matrix material used in the present invention may be epoxy or polyester in terms of costs and effectiveness. In addition, the reinforcing fibers used in the present invention may be glass fibers which are low-priced and have a suitable strength. In other embodiment, the reinforcing fibers can be other nonmetal fibers such as boron, carbon, graphite, Kevlar, and the like as described above.

In one embodiment of the compressor mounting base plate structure of the present invention, for example as shown in FIGS. 6-11, a pultrusion process is used with a polyurethane resin and a glass fiber reinforcement to form a composite. The thickness for the complete compressor mounting base plate structure can be from about 0.5 mm to about 20 mm in one embodiment; and from about 0.8 mm to about 5 mm in another embodiment.

The polyurethane resin and glass fiber composite material specification for the compressor mounting base plate structure made by a pultrusion process includes for example, a Young's Modulus of from about 1.0 GPa to about 100 GPa, and preferably from about 5 GPa to about 40 GPa; a Poisson's ratio of from about 0.01 to about 0.4 and preferably from about 0.1 to about 0.35 and a density of from about 500 Kg/m³ to about 4000 Kg/m³ and preferably from about 800 Kg/m³ to about 2500 Kg/m³.

The composite compressor mounting base plate structure of the present invention also exhibits other advantageous properties. For example, the tensile strength of the base plate can be from about 70 MPa to about 900 MPa in one embodiment; and from about 500 MPa to about 770 MPa in another preferred embodiment, as measured by the test method

### DIN EN ISO 527 (2012).

The flexural modulus of the base plate can be from about 3.5 GPa to about 40 GPa in one embodiment; and from about 10 GPa to about 34 GPa in another preferred embodiment, as measured by the test method DIN EN ISO 178 (2011).

Also, the % elongation of the base plate can be from about 1% to about 7% in one embodiment; and from about 1% to about 2.5% in another preferred embodiment, as measured by the test method DIN EN ISO 527 (2012).

Base plates made of polyurethane composite material exhibits better/excellent damping properties over base plates made of steel, providing vibration absorption characteristics transmitted by a compressor. For example, the damping increase of a composite material of the present invention base plate over steel can be generally from about 50% to about 900% in one embodiment, and from about 300% to about 700% in another embodiment.

The composite product which is a thermoset product (i.e. a cross-linked product made from the above-described formulation) of the present invention shows several improved properties over conventional products.

For example, the pultruded compressor mounting base plate structure of the present invention, which can be a composite product of polyurethane resin and glass fiber composite material, may have a glass transition temperature (Tg) generally from about 80° C. to about 150° C. in one embodiment; and from about 100° C. to about 120° C. in another embodiment. The Tg may be measured using a differential scanning calorimeter by scanning at 10° C./minute. The Tg can be determined by the inflection point of the 2^{nd} order transition.

The composite system of the present invention is used to prepare a compressor mounting plate for an appliance device, particularly a refrigerator.

The compressor mounting base plate structure of the present invention may be advantageously used in a refrigerator unit wherein the base plate structure is installed in the machine compartment of the refrigerator. To achieve the advantages in accordance with the purpose of the present invention, as embodied and broadly described herein, in general, there is provided a refrigerator including: (a) a refrigerator main body having a cooling chamber for storing foods; (b) a machine compartment; (c) a compressor mounting base plate structure installed in the machine compartment located at a lower portion of the refrigerator main body; said compressor mounting base plate structure adapted for receiving and supporting a compressor; and (d) a compressor mounted on the compressor mounting base plate structure. The compressor mounting base plate structure engages the machine compartment forming the bottom structure of the machine compartment casing and together with the lower portion of the refrigerator main body, the top surface of the base plate defines the machine compartment of the refrigerator.

Generally, a refrigerator is comprised of: a main body having a cooling chamber such as a freezing chamber and a refrigerating chamber therein; and a machine compartment positioned at a lower portion of a rear side of the main body and having various components forming a refrigeration cycle such as a compressor for compressing a refrigerant. Other parts of the refrigerator may include, for example, a control box for controlling the refrigeration cycle installed inside of the machine compartment and a separate water tray installed inside of the machine compartment for storing water generated from the refrigeration cycle by a defrosting operation.

The compressor mounting base plate structure of the present invention is mounted on a lower bottom portion of the machine compartment; and a compressor is mounted on the compressor mounting base plate structure. The compressor mounting base plate structure is affixed to the lower portion of the main body by any attachment which can be removable such as mounting brackets and one or more nuts and bolts.

In the present invention, the compressor can be installed on the compressor mounting base plate structure by mounting bracket system including a support bracket, a vibration preventing rubber member removably attached to the mounting bracket for preventing vibration generated from the compressor from being transferred to the main refrigerator body; and nuts and bolts to firmly affix the compressor to the base plate structure.

When the refrigerator containing the compressor mounting base plate structure of the present invention is constructed and operated as aforementioned, the improvements described above can be achieved.

### EXAMPLES

The following example is set forth herein below to further illustrate the present invention but is not to be construed to limit the scope thereof.

### Example 1

An example of a fiber-reinforced composite of an elongated non-metal, non-corrosive compressor mounting base plate structure for a refrigerator unit can be fabricated using a pultrusion process in accordance with the present invention as follows:

Pultrusion is a closed reactive process which uses a thermosetting resin and reinforcing fibers such as glass, carbon fiber, aramid, and polyester fibers. The forms of the reinforcement includes for example rovings (or tows, for carbon fiber), stitched rovings in different orientations, continuous strand mat, chopped strand mat, woven rovings, and bulk rovings. These fibers are pulled from a series of creels through an injection box, where the fibers are thoroughly mixed with a resin material such as polyurethane resin (other resins can include for example polyesters, vinyl esters, PVC, epoxies, phenolics, urethanes and blends thereof). Once the reinforcing fibers are impregnated with the resin, the impregnated material is passed through a heated steel die at a specified temperature (for example, at a temperature range of from about 80° C. to about 150° C.) where a resin matrix is shaped to the desired structure as shown in FIGS. 6-10; and then cured to form a “profile”. The profile is continually pulled through the die until the profile exits the die. The profile is cooled upon exiting the die and then cut to the desired length (for example, to a length in the range of from about 200 mm to about 750 mm).

1. An elongated non-metal, non-corrosive compressor mounting base plate structure comprising:
(I) a base plate segment having a top surface and a bottom surface, wherein the base plate segment is adapted for receiving a compressor on the top surface of the base plate;
(II) a means for receiving and removably affixing a compressor to the top surface of the base plate segment; and
(III) a reinforcement means integral with said base plate segment; wherein said reinforcement means includes at least two elongated tubular reinforcement segments integral with the base plate segment, one tubular reinforcement segment at each of the elongated sides of the base plate segment generally opposite each other in mirror image and generally parallel to each other along the longitudinal plane of the base plate segment; said reinforcement means being adapted for providing the compressor mounting base plate structure with sufficient strength and rigidity such that the compressor mounting base plate structure can withstand a deformation load from the weight of the compressor; and wherein the compressor mounting base plate structure comprises a non-metal, non-corrosive structure.

2. The compressor mounting base plate structure of claim 1, wherein the base plate segment comprises a substantially planar member having a top surface and a bottom surface and disposed centrally to the overall compressor mounting base plate structure; wherein the base plate segment is adapted for receiving a compressor on the top surface of the base plate, and wherein the base plate segment is adapted for receiving a means for removably mounting/affixing a compressor to the top surface of the base plate segment.

3. The compressor mounting base plate structure of claim 2, wherein the base plate segment includes a means for receiving and removably mounting/affixing a compressor to the top surface of the base plate segment.

4. The compressor mounting base plate structure of claim 3, wherein the means for receiving and removably mounting/affixing a compressor to the top surface of the base plate segment comprises (i) one or more orifices in the base plate segment for receiving therethrough a threaded bolt; (ii) one or more threaded bolts; and (iii) one or more threaded nuts for engaging and locking with the threaded bolt sufficient to secure the compressor on the base plate via support mounting brackets attached to the compressor.

5. The compressor mounting base plate structure of claim 1, including further (IV) a supplemental structural reinforcement means comprising at least a first and second reinforcing sections integrally connected to the base plate segment and integrally connected to the first and second reinforcing sections.

6. The compressor mounting base plate structure of claim 1, wherein the elongated reinforcement segments comprise at least a first reinforcing structure member and at least a second reinforcing structure member, each reinforcing structure member comprising an elongated top ledge portion, an elongated vertical sidewall portion, an elongated bottom ledge portion and an angled sidewall portion integral with each other forming a trapezoidal-shaped elongated member; and wherein the first and second reinforcing structure members are disposed integrally with the base plate segment; said first and second reinforcing structure members disposed on each side of the longitudinal length of the top surface of the base plate segment such that the first and second reinforcing structure members are disposed parallel to each other on opposite sides of the longitudinal length of the top surface of the base plate segment.

7. The compressor mounting base plate structure of claim 6, wherein the first reinforcing structure member and the second reinforcing structure member are trapezoidal-shaped tubular members when viewed in a cross-sectional view.

8. The compressor mounting base plate structure of claim 1, including further at least a first and second supplemental reinforcing sections being disposed transverse to the horizontal plane of the base plate segment at each extreme transverse end of the base plate segment.

9. The compressor mounting base plate structure of claim 1, including at least one load bearing/load distributing structure integral with the compressor mounting base plate structure and adapted for providing additional strength, reinforcement and integrity to the mounting base plate structure; wherein the at least one load bearing/load distributing structure is a raised surface area in at least a portion of the base plate segment adapted for receiving a compressor.

10. The compressor mounting base plate structure of claim 1, including a structure means integral with the base plate for removably attaching a means for moving the refrigerator unit once the compressor mounting base plate structure is affixed to an appliance unit; and wherein said means for moving the refrigerator unit is also adapted for moving the compressor mounting base plate structure to and from the appliance unit during installation of the compressor mounting base plate structure to the appliance unit; and wherein the structure means for moving the appliance unit comprises at least one or more wheel members removably attached to base plate segment.

11. The compressor mounting base plate structure of claim 1, including a means for attaching the compressor mounting base plate structure to an appliance unit.

12. The compressor mounting base plate structure of claim 1, wherein the compressor mounting base plate structure is rectangular in shape.

13. A process for manufacturing a compressor mounting base plate structure composite comprising subjecting a composite material to a pultrusion process to form a one piece compressor mounting base plate structure.

14. A refrigerator comprising a compressor mounting base plate structure of claim 1.

15. A refrigerator comprising
(a) a refrigerator main body having a cooling chamber for storing foods and a machine compartment;
(b) a compressor mounting base plate structure of claim 1 installed in the machine compartment of the refrigerator main body; said compressor mounting base plate structure adapted for receiving and supporting a compressor; and
(c) a compressor mounted on the compressor mounting base plate structure.
